(19) United States
(12) Patent Application Publication
(10) Pub. No.: US 2006/0291723 A1
(43) Pub. Date: Dec. 28, 2006

(54) Material processing apparatus, material processing method and material processing program

(75) Inventors: Toshiya Koyama, Kanagawa (JP); Teruka Saito, Kanagawa (JP); Hitoshi Okamoto, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/333,258

(22) Filed: Jan. 18, 2006

(30) Foreign Application Priority Data
Jun. 22, 2005 (JP) 2005-181385

(51) Int. Cl. G06K 9/00; G09B 7/00

(52) U.S. Cl. 382/181; 434/355

(57) ABSTRACT

An material processing apparatus: includes: an original information storage unit that stores an electronic data on a material having an answer column; an image input unit that obtain an image data from the material in which the answer column is filled with an answer and an accuracy judgment on the answer is added; an original retrieval unit that retrieves an electronic data on an original of the material out of the stored data; a target area acquisition unit that grasps a recognition target area from the electronic data on the original; an additional data extraction unit that extracts additional contents in the recognition target area from the image data; a calculation unit that performs marking summation of the accuracy judgment; and a print unit that prints the marking summation result of accuracy on the material on which the accuracy judgment is added.

### BACKGROUND OF THE INVENTION

1. Field of the Invention

The present invention relates to a material processing apparatus, a material processing method and a material processing program for processing a material used by an educational institution, an in particular to a material processing apparatus, a material processing method and a material processing program for performing marking processing for the material.

2. Description of the Related Art

In general, in an educational institution such as a school and a private cramming school, educational materials such as an examination paper and an exercise sheet are often used. It is a common practice to let a student enter an answer on the educational material and let a teacher mark the entered answer.

In the marking summation of an educational material involves recognition of the additional contents on the educational material. The recognition process is preferably based on the identification of the recognition target area on the educational material. This is because an identified recognition target area allows quick recognition of the additional contents with favorable accuracy.

On the other hand, educational materials as a target of marking summation are not always of a single type. That is, educational materials as a target of marking summation may include various types of educational materials. The recognition target area often differs with the type of educational material.

In case the marking summation of various types of educational materials is made, proper identification of the recognition target area may fail and an error may result in the recognition of additional contents, thus leading to a summation error. Or, additional workload may be required such as entering the specific type of the target educational material in marking summation.

### SUMMARY OF THE INVENTION

The invention provides a material processing apparatus, a material processing method and a material processing program for processing marking summation with improved accuracy and without additional workload while attaining labor-saving of the marking summation processing of plural types of materials.

The invention may provide a material processing apparatus, including: an original information memory that stores electronic data on a material having an answer column; an image input unit that reads an image of the material in which at least the answer column includes with an answer and an accuracy judgment on the answer is added, so as to obtain an image data from the material; an original retrieval unit that analyzes the image data obtained by the image input unit and that retrieves an electronic data on an original of the material from which the image data was obtained out of the data stored in the original information memory; a target area acquisition unit that grasps a recognition target area on the original from the electronic data on the original; an additional data extraction unit that extracts additional contents in the recognition target area from the image data; a calculation unit that performs marking summation of the accuracy judgment on the extraction result of the accuracy judgment out of the extraction result by the additional data extraction unit; and a print unit that prints the marking summation result of accuracy judgment by the calculation unit on the material on which the accuracy judgment is added.

The invention may provide a material processing method, including: storing an electronic data on a material having an answer column; obtaining an image data of the material by reading an image of a material in which at least the answer column is filled with an answer and an accuracy judgment on the answer is added; retrieving an electronic data on an original of the material out of the stored data by analyzing the obtained image data; grasping a recognition target area on the original from the retrieved electronic data on the original; extracting additional contents in the recognition target area from the obtained image data; calculating marking summation of the accuracy judgment on an extraction result of the accuracy judgment which is included in the extracted additional contents; and printing the marking summation result of accuracy judgment by the calculating step on the material where the accuracy judgment is added.

The invention may provide a program product for enabling a computer to process a material, including: software instructions for enabling the computer to perform predetermined operations; and a computer-readable recording medium bearing the software instructions; wherein the predetermined operations include: storing an electronic data on an original of the material; retrieving an electronic data on an original of the material out of the stored electronic data by analyzing an image data of the material in which an answer column is filled with an answer and an accuracy judgment on the answer is added; grasping a recognition target area on the original from the retrieved electronic data on the original; extracting additional contents in the recognition target area from the image data; calculating marking summation of the accuracy judgment on an extraction result of the accuracy judgment which is included in the extracted additional contents; and making a printer print the marking summation result of accuracy judgment on the material on which the accuracy judgment is added.

### BRIEF DESCRIPTION OF THE DRAWINGS

Embodiment may be described in detail with reference to the accompanying drawings, in which:

FIG. 1 is a block diagram showing a general configuration example of educational material processing apparatus according to the invention;

FIG. 2 is an explanatory drawing illustrating a specific example of an educational material;

FIG. 3 is an explanatory drawing illustrating a specific example of an recognition target area information;

FIG. 4 is a block diagram showing a specific system configuration example of educational material processing apparatus according to the invention;

FIG. 5 is an explanatory drawing that illustrates the outline of the basic processing operation of the educational material processing apparatus according to the invention;

FIGS. 6A and 6B are explanatory drawings illustrating an example of disconnection correction;

FIGS. 7A and 7B show another example of disconnection correction;

FIG. 8 is a flowchart showing an example of accuracy judgment marking summation procedure; and

FIG. 9 is an explanatory drawing illustrating a specific example of the question-based marking result.

### DETAILED DESCRIPTION OF THE INVENTION

The material processing apparatus, the material processing method and the processing program according to the invention will be described based on drawings.

[Description of Basic Functional Configuration]

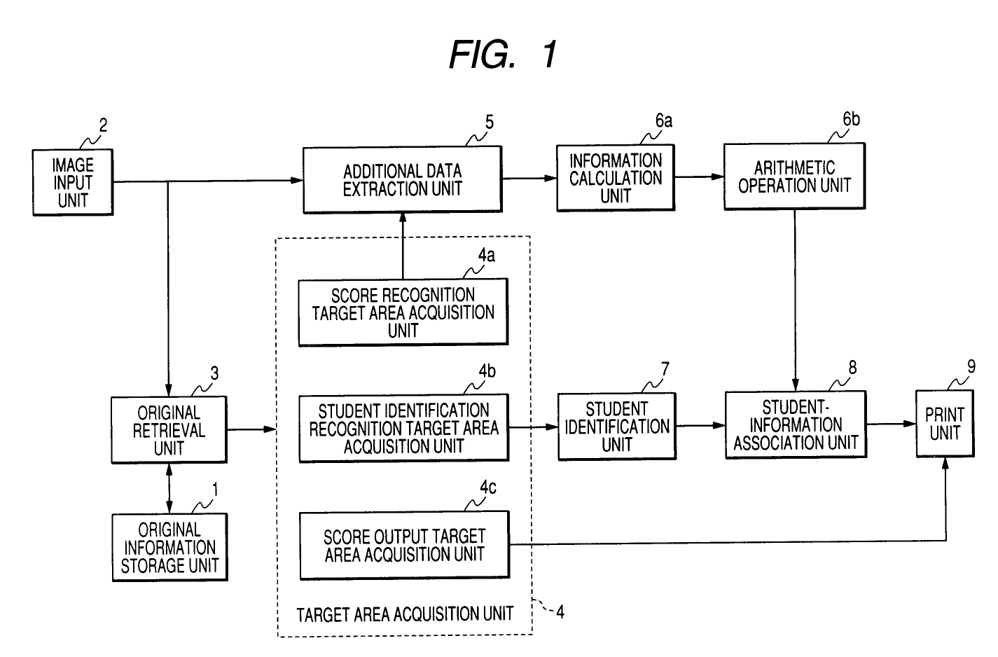

Basic functional configuration of the educational material processing apparatus will be described. FIG. 1 is a block diagram showing a functional configuration example of educational material processing apparatus according to the invention. As shown in FIG. 1, the educational material processing apparatus includes an original information storage unit 1, an image input unit 2, an original retrieval unit 3, a target area acquisition unit 4, an additional data extraction unit 5, an information calculation unit 6a, an arithmetic operation unit 6b, a student identification unit 7, a student-information association unit 8, and a print unit 9.

The original information storage unit 1 stores electronic data on a target educational material whose answer column is not filled in as electronic data to identify the original of the educational material. The original information storage unit 1 is capable of storing electronic data on the original of each of the plural types of educational materials.

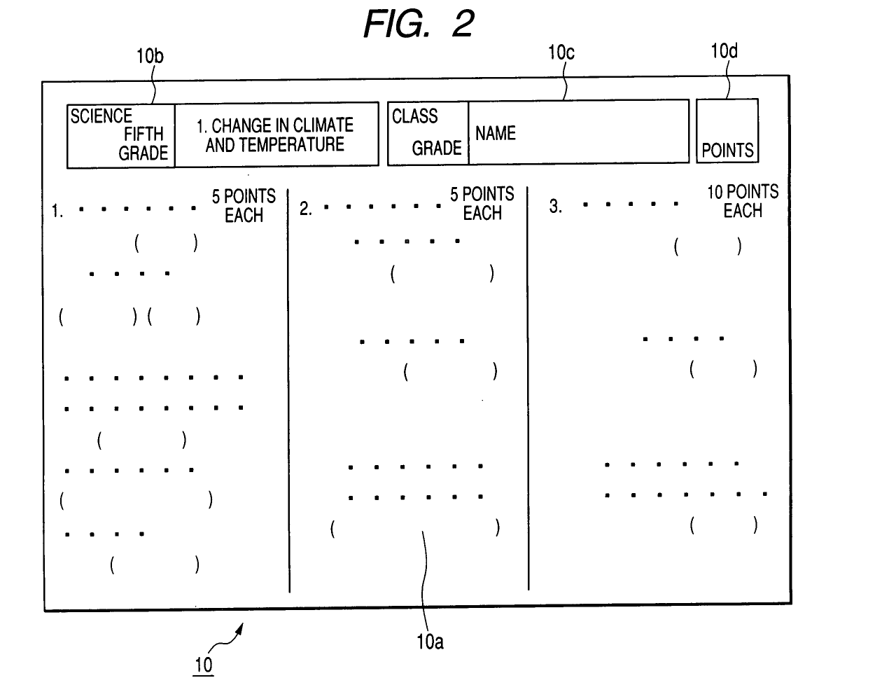

The original of an educational material is described below. FIG. 2 is an explanatory drawing illustrating a specific example of an educational material. As shown in FIG. 2, the educational material 10 includes questions and the associated answer columns 10a. In particular, an examination paper or an exercise sheet used by an educational institution corresponds to the educational material. The educational material 10 must include at least an answer column 10a and question text is not mandatory.

The educational material 10 includes an identification information column 10a for identifying the educational material 10 and an answerer information column 10c on the person that has filled in the answer column 10a. The identification information column 10b shall previously bear the subject, title and applicable grade. On top of such description, or separately from such description, code information to identify the educational material 10 may be embedded. The code information may be embedded using a well-known technique. One example of such technique is for example “iTone®” where the form (position, shape) of pixels constituting a full line screen or a dot screen as gradation representation is changed so as to embed digital information into a halftone image. The answerer information column 10c is designed to fill in the class, student number, and name of the person who entered the answer.

The educational material 10 includes an information output column 10d. The information output column 10d is designed to fill in the total score of the answers in the answer columns 10a and other information associated with the total store, for example, an average value, an overall ranking and a deviation value on a per class basis or on a per grade basis.

The electronic data on such an educational material 10 may be of any data format as long as it can be stored on the original information storage unit 1. For example, bitmap-format image data or application document data created with word-processing software maybe used. The electronic data on the educational material 10 shall include data to identify the image of question text, answer column 10a and identification information column 10b on the educational material (hereinafter referred to as original image data) as well as information to identify the attributes (subject, title, applicable grade) and allotted points to the answer columns 10a on the educational material 10 (hereinafter referred to as original image information). The original image information is used to identify the points allotted to a specific answer column 10a at a position on the educational material 10. Points allotted to the answer columns 10 may be different or the same.

The electronic data on the educational material 10 shall include information to identify the positions of a score recognition target area, a student identification recognition target area and a score output target area (hereinafter referred to as “recognition target area information”) that are preset on the educational material 10 mentioned later. The score recognition target area is an area where the accuracy judgment on the answer filled in the answer column 10a (for example a figure of “O” or “x”) is added. In particular, the score recognition target area is an area overlapping the answer column 10a or an area identical with that of the answer column 10a. The student identification recognition target area is an area to identify the person (student) who has filled in an answer in the answer column 10a. In particular, the answerer information column 10c corresponds to the student identification recognition target area. The score output target area is an area for outputting the total score of the answers filled in the answer columns 10a and associated information. In particular, the information output column 10s corresponds to score output target area.

The recognition target area information to identify the position of each of these areas may be represented using coordinates on the educational material 10.

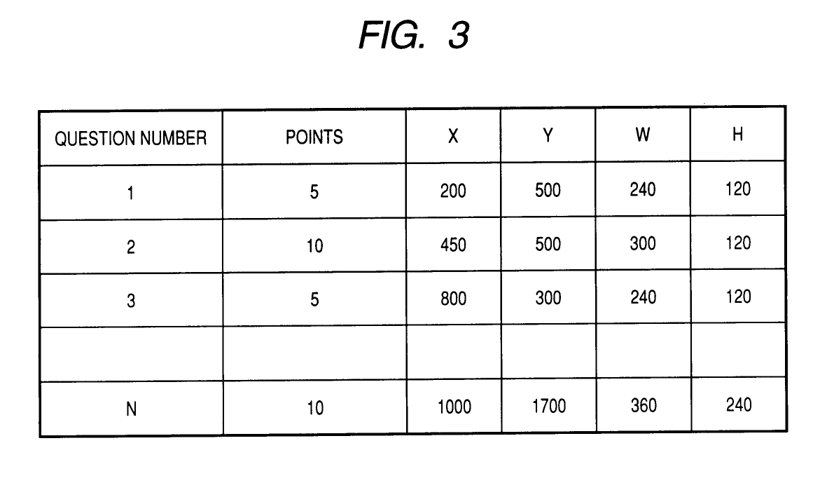

FIG. 3 is an explanatory drawing illustrating a specific example of recognition target area information. FIG. 3 shows an example of recognition target area information to identify the position of a score recognition target area. As shown in FIG. 3, the recognition target area information to identify the score recognition target area includes information consisting of the xy coordinates of a predetermined point (for example the upper left apex) of a score recognition target area on a educational material 10 and the width (W) and height (H) of its circumscribed rectangle. In general, a plurality of answer columns 10s exist on an educational material 10, so that the information to identify a score recognition target area has corresponding coordinate position individually set per score recognition target area. Each score recognition target area may have clear relation with respective coordinate positions and original image information. In particular, correspondence between the information on the number of a question (or answer column 10a) on the educational material 10 and the information to identify the points allotted to the answer to the question (hereinafter referred to as “allotted points information”) is clarified for example in a table format shown.

In FIG. 1, image input unit 2 performs image reading of an educational material 10 where an answer is filed in the answer column 10a and name filled in the answerer information column 10c and accuracy judgment on the answer (to be precise a figure of “O” or “x”) is entered, by using a well-known optical image read technique in order to obtain image data from the educational material 10.

The original retrieval unit 3 analyses the image data obtained by the image input unit 2 and retrieves the electronic data on the original of the educational material from which the image data is obtained out of the electronic data stored in the original information storage unit 1. The retrieval may take place based on the analysis result of the part of the identification information column 10b on the educational material 10.

When the original retrieval unit 3 retrieves the electronic data on the original of the educational material 10, the target area acquisition unit 4 acquires the recognition target area information included in the electronic data to identify the positions of the score recognition target area, student identification recognition target area and score output target area on the educational material 10. For this purpose, the target area acquisition unit 4 comprises score recognition target area acquisition unit 4a for identifying the position of each of the score recognition target area, student identification recognition target area acquisition unit 4b for identifying the position of the student identification recognition target area, and score output target area acquisition unit 4c for identifying the position of the score output target area.

The additional data extraction unit 5 extracts the additional contents on the educational material 10, in particular the additional contents of accuracy judgment based on the image data on the educational material 10 and the recognition target area information on the score recognition target area obtained by the score recognition target area acquisition unit 4a of the target area acquisition unit in order to recognize the additional contents of the accuracy judgment. Extraction of the additional entry of accuracy judgment is made for example by comparing the image data on the educational material 10 obtained by the image input unit 2 wit the original image data stored in the original information storage unit 1 and extracting the difference between them as well as extracting the difference between a predetermined color component, or a red color component of the difference. This is because additional accuracy judgment is made using the red color. The technique of difference extraction uses a well-known image processing technique so that the corresponding details are omitted. Recognition of the additional entry of accuracy judgment is made by judging whether the shape judgment of the extraction result to the additional entry of accuracy judgment or to be more specific, whether the judgment is ‘O’ or ‘x’. The shape judgment is made for example by judging “a correct answer (O)” or “an incorrect answer (x). The shape judgment in this case is performed for example through pattern matching with the figure shape of “O” or 37 x”. Or, the shape may be recognized by calculating the characteristic amount of the recognition target figure and based on the obtained characteristic amount. The score output target area may be the number of holes or the ratio of the area of the target FIG. to the area of its circumscribed rectangle.

The information calculation unit 6a performs marking summation of accuracy judgment entered on the educational material 10 from which the image input unit 2 performed image reading based on the recognition result of the accuracy judgment by the additional data extraction unit 5 and the original image information (especially allotted points information) stored in the original retrieval unit 3 in order to calculate the total store on the educational material 10.

The arithmetic operation unit 6b performs arithmetic operation to obtain other information associated with the total store as a calculation result by the information calculation unit 6a, for example an average score, overall ranking and deviation value on a per class basis or on a per grade basis. The target information shall be predetermined.

The student identification unit 7 extracts the additional contents on the educational material 10, in particular the additional contents into the answerer information column 10c based on the image data obtained by the image input unit 2 and the student identification recognition target area obtained by the student identification recognition target area acquisition unit 4b of the target area acquisition unit 4 in order to identify a person (student) who has entered an answer on the educational material 10. The technique to identify the answer entering person maybe a well-known character recognition technique so that the corresponding details are omitted.

The student-information association unit 8 associates the calculation result by the information calculation unit 6a and the arithmetic operation result by the arithmetic operation unit 6b and the identification result if the answer entering person by the student identification unit 7 with each other. By this association, the calculation result and the arithmetic operation result and the identification result of the answer entering person obtained from the same educational material 10 are associated with each other. The result of association by the student-information association unit 8 may be output to database apparatus or file server apparatus (either is not shown) for managing the marking summation result on the educational material 10 for storage thereon.

The print unit 9 prints the calculation result by the ii calculation unit 6a and the arithmetic operation result by the arithmetic operation unit 6b in the score output target area on the educational material 10 where the calculation result and the arithmetic operation result are obtained, the score output target area identified by the score output target area acquisition unit 4c of the target area acquisition unit 4, by using a well-known electronic photography technique.

[Description of a Specific General Configuration]

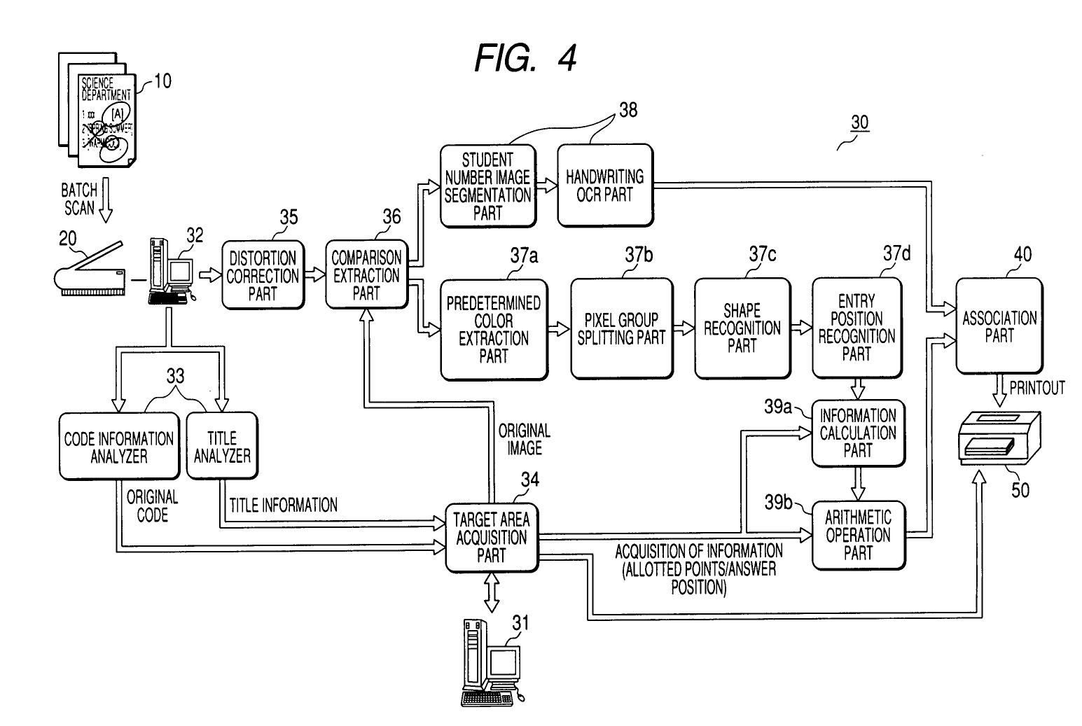

A system configuration to provide educational material processing apparatus having the above functional configuration will be described by way of a specific example. FIG. 4 is a block diagram showing a specific system configuration example of educational material processing apparatus according to the invention. As shown in FIG. 4, the system described here is roughly composed of a scanner 20, a data processor 30, a printer 50, and a wired or wireless communication circuit (not shown) connecting these with each other.

The scanner 20 obtains data from the target educational material 10 in order to provide a function as image input unit 2 described above. The scanner 20 has an ADF (Automatic Document Feeder) so as to continuously read image data from a plurality of educational materials 10.

The data processor 30 uses the functions of a computer device providing the image storage processing function, image processing function, and arithmetic operation processing function to perform marking summation that is based on processing of image data obtained by the scanner 20 and its data processing result. For this purpose, the data processor 30 includes a database part 31, an image data analysis part 32, an educational material determination part 33, a target area acquisition part 34, a distortion correction part 35, a comparison extraction part 36, a predetermined color extraction part 37a, a pixel group splitting part 37b, a shape recognition part 37c, an entry position recognition part 37d, an answerer extraction part 38, an information calculation part 39a, an arithmetic operation part 39b, and an association part 40.

The database part 31 stores the electronic data on the target educational material 10 (original image data, original image information and recognition target area information). That is, the database part 31 provides the function of the aforementioned original information storage unit 1.

The image data analysis part 32 analyzes the image data obtained by the scanner 20. Analysis methods include layout analysis, character/figure splitting, character recognition, code information recognition, figure processing, and color component recognition, all of which are provided by using a well-known image processing technique so that the corresponding details are omitted.

The educational material determination part 33 is composed of at least a title analysis part and a code information analysis part. The educational material determination part 33 identifies the educational material 10 as a source of image data obtained by the scanner 20 based on the result of analysis by the image data analysis part 32, in particular the result of at least either the title analysis of the identification information column 10b by the title analysis part or code analysis on the same by the code analysis part. In the educational material determination part 33, the database part 31 matches the electronic data with the stored educational material 10. In case the corresponding electronic data is not stored in the database part 31, an identification error of an educational material is assumed. That is, the educational material determination part 33 identifies the electronic data on the original to be compared wit the image data obtained by the scanner 20 from the analysis result by the image data analysis part 32, and retrieves the electronic data from the electronic data stored in the database part 31 so as to provide a function as the original retrieval unit 3.

The target area acquisition part 34, retrieving the electronic data on the original of the educational material 10 from the database part 31, acquires the recognition target area information included in the electronic data and identifies the position of each of the score recognition target area, student identification recognition target area and score output target area on the educational material 10. That is, the target area acquisition part 34 provides the function s the target area acquisition unit 4.

The distortion correction part 35 corrects image distortion in the image data obtained by the scanner 20. Correction of image distortion includes inclination correction and expansion/contraction correction in the main scan direction or sub scan direction. Further, the distortion correction part 35 may match the image data obtained by the scan part 20 with the electronic data on the database part 31 as comparison data, and correct the image distortion (inclination and expansion/contraction). Either correction may be provided by using a well-known technique, so that the corresponding details are omitted.

The comparison extraction part 36 compares the image data obtained by the scanner 20 that has been subjected to image distortion correction in the distortion correction part 35 with the electronic data on the original of the educational material 10 retrieved from the database part 31 that has been read by the scanner 20, and extracts the difference therebetween. The comparison extraction part 36 is so designed as to perform difference extraction only for the score recognition target area and student identification recognition target area based on the identification result on the score recognition target area and student identification recognition target area by the target area acquisition part 34.

The predetermined color extraction part 37a extracts the difference in a predetermined color component (for example red color component) from the difference extracted by the comparison extraction part 36 to extract the accuracy judgment contents.

The pixel group splitting part 37b obtains a pixel group that is expected to configure a single figure shape (“0” or “x”) for the extraction result as well as performs disconnection correction on the pixel group detailed later. The disconnection correction refers to processing that connects extracted line segments to eliminate the disconnections between the extracted line segments.

The shape recognition part 37c performs shape recognition of “O” or “x” on the accuracy judgment contents extracted by the predetermined color extraction part 37a and organized into a pixel group by the pixel group splitting part 37b so as to recognize the accuracy judgment contents.

The entry position recognition part 37d recognizes the entry position of the accuracy judgment contents on the educational material 10 whose shape has been recognized by the shape recognition part 37c.

The predetermined color extraction part 37a, the pixel group splitting part 37b, the shape recognition part 37c, and the entry position recognition part 37d provides the function as the additional data extraction unit 5 mentioned above.

The answerer extraction part 38 is composed of at least either a student number information segmentation part and a handwriting OCR (Optical Character Reader) part or preferably both of them. The answerer extraction part 38 extracts the answerer information on the educational material as a target of reading by the scanner 20, by way of character information extraction by the student number information segmentation part and character recognition by the handwriting OCR part from the difference on the student identification recognition target area out of the difference extracted by the comparison extraction part 36, based on the identification result on the student identification recognition target area by the target area acquisition part 34. The answerer information includes information to identify the answer entering person such as the class, student number and name of the answer entering person.

In other words, the comparison extraction part 36 and the answerer extraction part 38 provide the function as the student identification unit 7.

The information calculation part 39a performs marking summation and calculates the total score concerning the accuracy judgment entered on the educational material 10 that has been read by the scanner 20 based on the recognition result of the accuracy judgment by the shape recognition part 37c, the recognition result of the entry position of the accuracy judgment by the entry position recognition part 37d, and the allotted points information on each answer column 10a out of the original image information stored in the database part 31.

The arithmetic operation part 39b performs arithmetic operation to obtain other information associated with the total score as a calculation result by the information calculation part 39a, such as an average score, overall ranking, and deviation value on a per class basis or on a per grade basis. The arithmetic operation part 39b provides the function as the arithmetic operation unit 6b.

The association part 40 associates the calculation result by the information calculation part 39a and the arithmetic operation result by the arithmetic operation part 39b and the extraction result of the answer entering person by the answerer extraction part 38 with each other. The association part 40 provides the function as the student-information association unit 8.

The printer 50 prints the processing result by the data processor 30, or to be more specific, the calculation result by the information calculation part 39a and the arithmetic operation result by the arithmetic operation part 39b on a educational material 10 from which the calculation result and the arithmetic operation result were obtained. The printer 50 is designed to perform printing for the score output target area identified by the target area acquisition part 34. The printer 50 provides the function as the print unit 9.

The printer 50 is designed to perform printing on a medium taken out sheet by sheet from a feeder tray. Thus, before the printer 50 starts printing, an educational material 10 as a target of printing, that is, an educational material 10 subjected to image reading by the scanner 20 is set in the feeder tray of the printer 50.

In this case, the educational material 10 subjected to image reading may be carried into the feeder tray of the printer 50 via a carrier path (not shown). That is, a carrier path is previously provided for carrying a educational material 10 between the scanner 20 and the printer 50 so that the educational material 10, once subjected to image reading by the scanner section 20 will be automatically carried into the feeder tray of the printer 50.

The educational material 10 need not always carried automatically. Transfer of the educational material 10 from the scanner 20 to the printer 50 is manually made. Manual transfer may cause a difference between the order of image reading by the scanner 20 and the order of sheet setting into the feeder tray of the printer 50. Thus, an information read processor (not shown) for identifying the educational material 10 to be printed by a printer engine part is preferably arranged between the feeder tray and the printer engine part. The information read processor may comprise, for example, a read sensor for reading information from a predetermined section on the educational material 10 and an information processor for identifying the educational material 10 in the same manner as the educational material determination part 33 and the answerer extraction part 38.

Parts 31 through 40 constituting the data processor 30 of the educational material apparatus of a system configuration including the scanner 20, the xxx 30 and the printer 50 may be implemented by previously installing a predetermined program in a computer device and executing the predetermined program. In this case, the predetermined program for implementing the parts 31 through 40 may not be pre-installed but may be provided while stored on a computer-readable recording medium, or may be delivered via wired or wireless communications unit. That is, the educational material of the above configuration may be implemented by an educational material processing program that causes a computer connected to the scanner (image reader device) 10 and the printer (printer device) 30 to work as educational material processing apparatus.

[Description of Outline of Processing Operation]

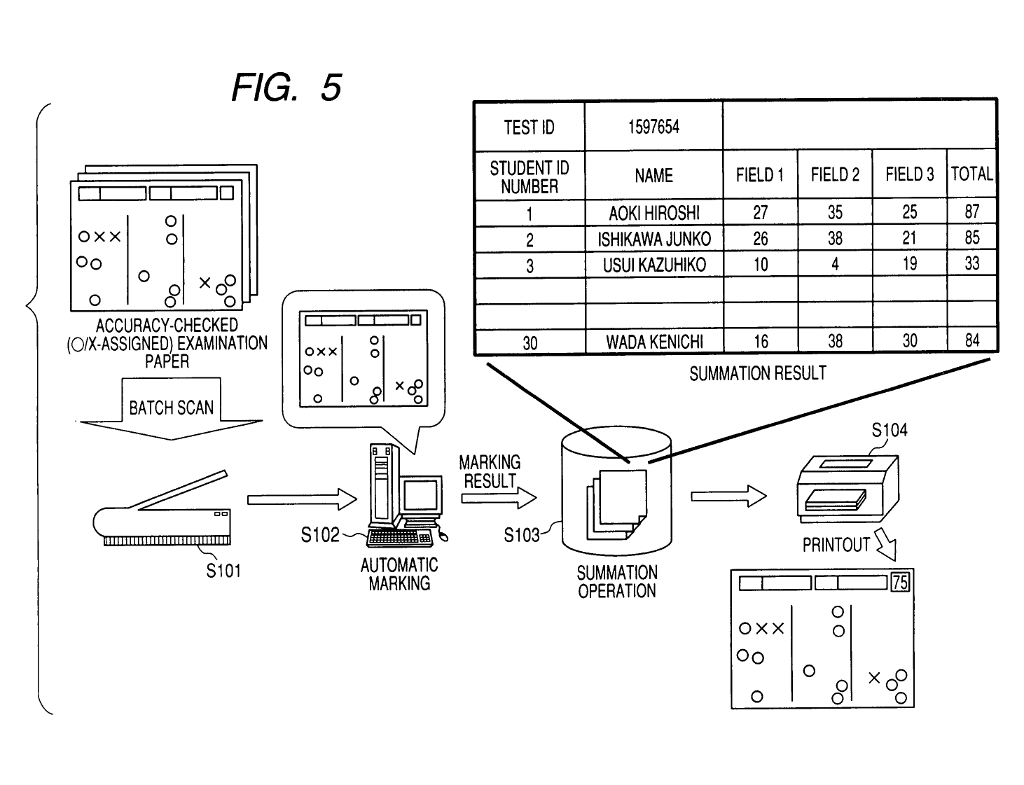

The processing operation example of the educational material processing apparatus thus configured (including a case where the apparatus is implemented by way of an educational material program also), that is, a method for processing an educational material will be described. FIG. 5 is an explanatory drawing that illustrates the outline of the basic processing operation of the educational material processing apparatus according to the invention.

In case educational material processing apparatus is used a student enters his/her name and other information in the answerer information column 10c and enters an answer in the answer column 10a. Next, the scanner 20 reads the image of an educational material subjected to entry of a figure for accuracy judgment such as “O” or “x” on the answer entered in each answer column 10a by a teacher, and acquires image data from the educational material 10 (step 101; hereinafter a step is abbreviated as “S”). In this practice, use of ADF continuously obtains image data from each educational material 10 by performing batch reading from a plurality of educational materials 10 to be organized into a single group such as the same class for group-based processing.

The image data obtained via image reading by the scanner 20 is transmitted to the xxx 30 and temporarily retained in memory use as a work area of the xxx 30. All the educational material 10 subjected to image reading shall be transferred to the heeder tray of the printer 50 via an automatic carrier path or manually by man-power of a teacher. In this practice, setting of the educational material 10 into the feeder tray is desirably performed in the same order of the image reading in the scanner 20.

Then automatic marking is sequentially made on the respective image data obtained from each educational material (S102). The automatic marking will be detailed later. After the marking of the accuracy judgment on each educational material is summed up in the automatic marking to obtain the respective total score, summation operation to be detailed later takes place (S103). In the summation operation, the calculation result of respective total score is associated with the answer information obtained from each educational material 10 to perform arithmetic operation on other information associated with the total score such as an average score, overall ranking, and deviation value on a per class basis or on a per grade basis.

When the automatic marking and summation operation are complete in the xxx 30, the printer 50 sequentially prints the calculation result of the automatic marking and the arithmetic operation result of the summation operation for each educational material 10 set in the feeder tray (S104). In case the educational material 10 in the feeder tray is set in the order of image reading in the scanner 20, it is possible to print the calculation result of the automatic marking and the arithmetic operation result of the summation operation in the order the images are read, that is, in the processing order of automatic marking and summation operation. The calculation result of the automatic marking and the arithmetic operation result of the summation operation are added in the information output column 10d of the educational material 10 that acquired the calculation result and arithmetic operation result.

The automatic marking, the summation operation and the printout processing in the above processing operation example will be further described.

[Description of Automatic Marking]

Automatic marking is made in the following procedure. In the automatic marking, in the xxx 30, the image data analysis part 32 analyzes the image data obtained from a single educational material 10 and the educational material determination part 33 identifies the educational material based on the result of analysis. The identification may be made through analysis of title such as “science”, “fifth grade”, “1. Change in climate and temperature” or code analysis on the code information embedded in the identification information column 10b. With this identification, the educational material determination part 33 identifies the electronic data on the original to be compared with the image data obtained by the scanner 20 and retrieves the electronic data from the electronic data stored in the database part 31. Although the identification may be sequentially made of a plurality of educational materials 10 subjected to image reading by the scanner 20, the educational material 10 collectively processed as a group is the same material without exception. Thus, it is sufficient to identify the first educational material 10 to be processed first in the group. Retrieval of electronic data on the original may be made by using a well-known technique, so that the corresponding details are omitted.

In case the electronic data identified by the educational material determination part 33 is present in the database part 31, the target area acquisition part 34 acquires the recognition target area information included in the electronic data. This identifies the position of each of the score recognition target area, student identification recognition target area and score output target area on the educational material 10.

On the other hand, the image data obtained from a single educational material 10 is subjected to image distortion correction by the distortion correction part 35. Correction of the image distortion is made to correct image distortion that may accompany image reading in the scanner 20 and used to improve accuracy of comparison between the image data and the electronic data and difference extraction.

The comparison extraction part 36 compares the image data subjected to correction of image distortion by the distortion correction part 35 with the electronic data on the original of a single educational material 10, that is, the electronic data retrieved from the database part 31 by the educational material determination part 33, and extracts the difference therebetween. In this practice, the comparison extraction part 36 extracts the difference between the original image data and the electronic data on the original only for the identification result by the target area acquisition part 34, or to be more precise, the score recognition target area and the student identification recognition target area identified by the target area acquisition part 34, rather than all the areas of the educational material 10. The difference extraction process extracts the contents of the answerer information column 10c and each answer column 10a as well as the contents of the accuracy judgment on each answer column.

When the comparison extraction part 36 extracts a difference, the answerer extraction part 38 extracts the answerer information on the educational material as a target of reading by the scanner 20 via character recognition processing concerning the difference. This makes it possible to identify the class student number and name of the answer entering parson that has entered an answer in an educational material 10.

For the difference extraction result by the comparison extraction part 36, the predetermined color extraction part 37a further extracts a predetermined color component, in particular a red color component from the difference extraction result. Extraction of the red color component is made by focusing on the color component data constituting pixel data in case the difference extraction result is composed of the pixel data.

In general, a plurality of answer columns 10a are present on the educational material 10. Entry of accuracy judgment is made on plural section of the educational material 10. Thus, in order to recognize the contents of the accuracy judgment, these answer column ray used to be separately handled.

From this, the pixel group splitting part 37b performs pixel group splitting on the extraction result by the predetermined color extraction part 37a. Pixel group splitting may be made by handling a group of pixels in close proximity to each other as a single group. Pixels positioned closer to each other than a preset distance are determined to configure a single figure shape. A group of consecutive pixels in its close proximity is subjected to labeling processing as a general image processing technology to allow discrimination from another consecutive pixel group. Use of the labeling processing allows a consecutive pixel group that is expected to configure a single figure shape (“O” or “x”) to be handled as a group after pixel group splitting.

In case the score recognition target area is individually set to each answer column 10a, it is possible to handle a consecutive pixel group that is expected to configure a single figure shape (“O” or “x”) as a single group by discriminating respective score recognition target areas. In such a case, as long as labeling processing is made to discriminate the score recognition target area, the above processing for pixel group splitting may be omitted.

The pixel group splitting part 37b also performs disconnection correction on the extraction result by the predetermined color extraction part 37a. Entry of a figure for accuracy judgment on the educational material 10 such as “O” or “x” often takes place while overlapping the question text, the frame to define each answer column 10a, and entry of answer in each answer column 10a and the overlapping sections are likely to be removed from the extraction result of a predetermined color component by the predetermined color extraction part 37a. That is, A figure such as “O” or “x” may include disconnected sections.

Disconnection correction performed by the pixel group splitting part 37b will be detailed.

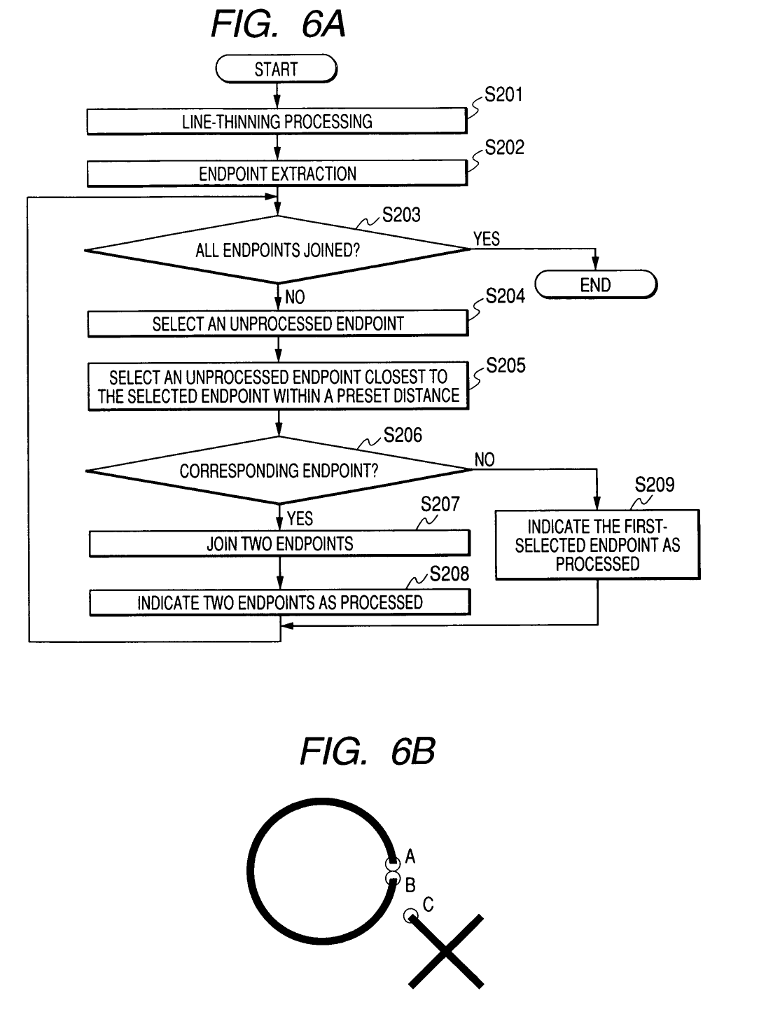

FIGS. 6A and 6B are explanatory drawings illustrating an example of disconnection correction.

In disconnection correction, as shown in FIG. 6A, the extraction result of the predetermined color component by the predetermined color extraction part 37a that is, the extraction result of a figure that is expected to be “O” or “x” is subjected to line-thinning processing (S201) followed by endpoint extraction (S202). In case a figure of “O” or “x” includes a disconnected section, the endpoints of the disconnected section is extracted. The line-thinning processing and the endpoint extraction are performed by using a well-known technique so that the corresponding details are omitted.

When the endpoints are extracted, the following processing is performed on all the extracted points (S203). Once unprocessed endpoint is selected (S204). Another unprocessed endpoint (hereinafter referred to as the “second endpoint”) that is closest to the selected endpoint (hereinafter referred to as the “first endpoint”) within a preset distance from the first endpoint is selected (S205). In case the second endpoint is present (S206), the first endpoint and the second endpoint are joined together (S207) and the first endpoint and the second endpoint are indicated as processed (S208). In case the second endpoint is absent (S206), the endpoints are not joined and the first endpoint is indicated as processed (S209). This processing is repeated for all endpoints until there are no longer unprocessed endpoints (S203-S209).

In case a figure shown in FIG. 6B is extracted, even though endpoints B and C are present with respect to the endpoint A, the closest endpoint B is joined to the endpoint A and the disconnected section in the figure of “O” is corrected.

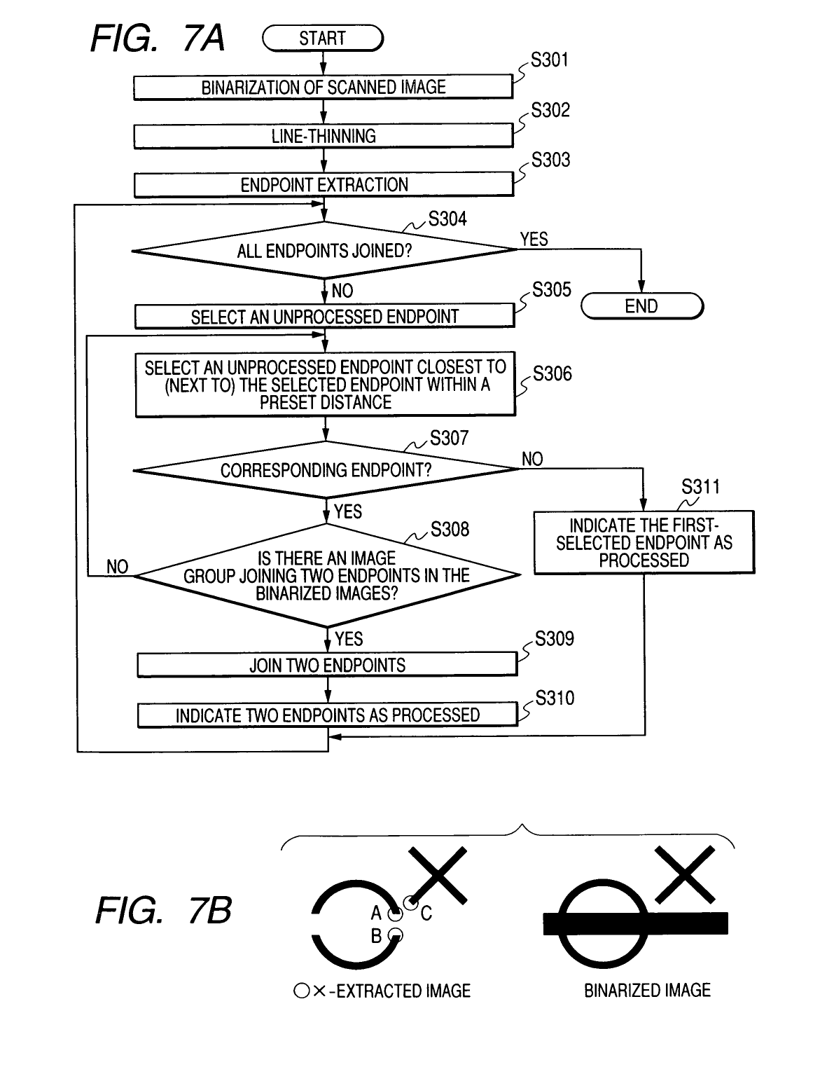

FIGS. 7A and 7B show another example of disconnection correction.

In this example of disconnection correction, the extraction result of a predetermined color component by the predetermined color extraction part 37a as well as the image data subjected to image distortion correction by the distortion correction part 35 is used to improve the accuracy of disconnection correction. That is, in this example of disconnection correction, as shown in FIG. 7A, the image data subjected to image distortion correction by the-distortion correction part 36 undergoes binarization (S301). In case binarization is already made in difference extraction by the comparison extraction part 36 or extraction of a predetermined color component by the predetermined color extraction part 37a, the image data subjected to binarization may be used.

Line-thinning processing is performed (S302) and endpoint extraction processing is performed (S303) on the extraction result of a predetermined color component by the predetermined color extraction part 37a. When the endpoints are extracted, the following processing is performed on all the extracted points (S304). One unprocessed endpoint is selected (S305). Another unprocessed endpoint that is closest to the selected first endpoint within a preset distance from the first endpoint is selected as the second endpoint (S306). In case the second endpoint is present (S307), it is determined whether a pixel group coupling the first endpoint and the second endpoint is present in the binarized image data (S308). In other words, it is determined whether there is overlapping of images attributable to disconnection. In case overlap is found, the first endpoint and the second endpoint are joined together (S309) and the first endpoint and the second endpoint are indicated as processed (S310). In case over lap not found, control returns to the above step (S306) where another unprocessed endpoint that is closest to the first endpoint within a preset distance from the first endpoint is selected as the second endpoint. In case there was no endpoint to be selected, the endpoints are not found, the endpoints are not joined and the first endpoint is indicated as processed (S311). This processing is repeated for all endpoints until there are no longer unprocessed endpoints (S304-S311).

In case a figure shown in FIG. 7B is extracted, when endpoints B, C are present with respect to the endpoint A, the closest endpoint C is selected. However, in the absence of a pixel block connecting the endpoints B, C in the binarized image data, the endpoints A and C are not joined. Then, the second closest endpoint B is selected. A pixel group is present in the binarized image data between the endpoint B and the endpoint A. Thus the endpoint B is joined to the endpoint A. In this way, the disconnected section in the figure of “O” is corrected without “O” and “x” being inadvertently joined.

After the processing by the pixel group splitting part 37b, the shape recognition part 37c performs shape recognition of the contents of accuracy judgment, or performs pattern matching with the figure shape of “O” or “x” and recognizes whether the contents of the is a “correct answer” or a “wrong answer”. The pattern patching may be performed by using a well-known technique so that the corresponding description is omitted.

Or, the characteristic amount of the recognition target figure may be calculated and the shape of the figure may be recognized based on the characteristic amount. The characteristic amount may be a well-known amount such as the number of holes or the ratio of the area of the target figure to the area of its circumscribed rectangle. The corresponding description is omitted.

When the shape recognition part 37c performs recognition of shape on the contents of accuracy judgment, the entry position recognition part 37d recognizes the entry position of the contents of the accuracy judgment on the educational material 10. Recognition of the entry position may be made by using the position information on the score recognition target area including extracted entry of the accuracy judgment, or by calculating the circumscribed rectangle of the figure of “O” or “x” and further calculating the center coordinates of the circumscribed rectangle.

After the entry position recognition part 37d has recognized the accuracy judgment entry position of, the information calculation part 39a performs marking summation of the accuracy judgment. The information calculation part 39a performs marking summation of the accuracy judgment based on the recognition result on the entry position of accuracy judgment by the shape recognition part 37c, the entry position of accuracy judgment by the entry position recognition part 37d, and the original image information included in the electronic data on the educational material 10 stored by-the data base part 31 (in particular the allotted points information on each answer column 10a of the educational material 10).

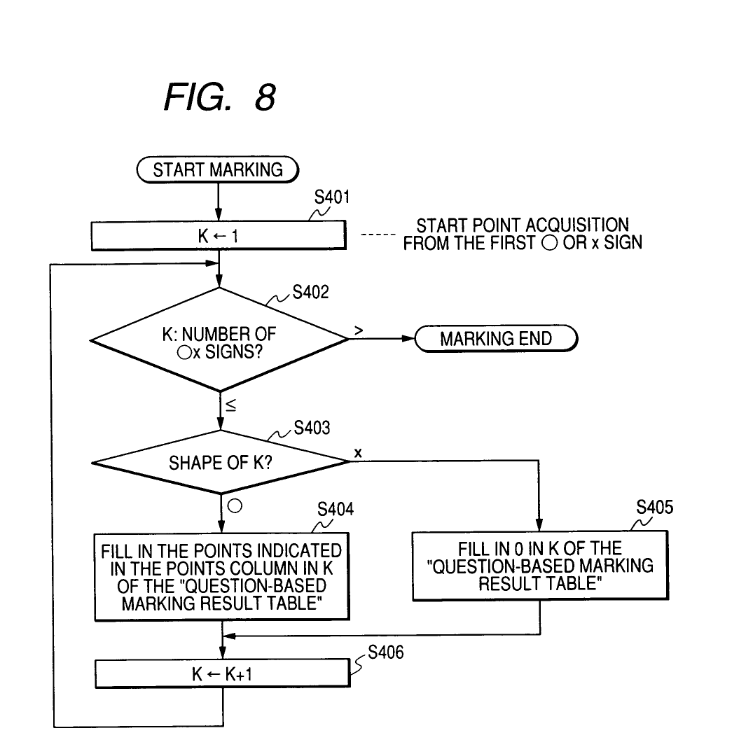

The marking summation of accuracy judgment by the information calculation part 39a will be further described. FIG. 8 is a flowchart showing an example of accuracy judgment marking summation procedure.

In the marking summation of accuracy judgment, a plurality of accuracy judgments are entered on the educational material 10. First, the count K of the accuracy judgment is set to “1” (S401). Accordingly, marking summation processing is performed in order starting with the first accuracy judgment on the accuracy judgments (figure of “O” or “x”) detected in a predetermined scan order until the count K exceeds the number of accuracy judgments that can exist on the educational material 10, namely until the count K exceeds the number in the answer column 10a (S402).

It is determined whether the shape of the Kth figure in the shape of “O” or “x” is “O” or “x” (S403). In case the shape is “O”, the points allotted to the answer to the question of count K are added (S404). In case the shape is “x”, the points allotted to the answer to the question of count K are not added but “0 points” are added instead (S405).

This processing is repeated while incrementing the count K value (S406) until all accuracy judgments are complete on the educational material 10 (S402-S406).

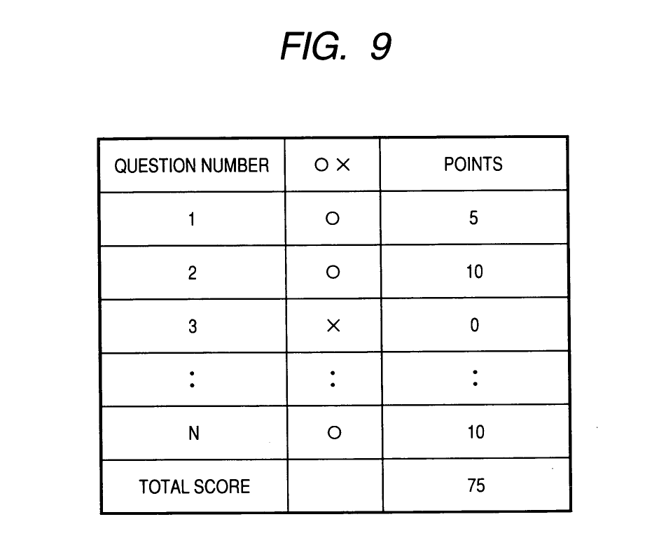

FIG. 9 is an explanatory drawing illustrating a specific example of the question-based marking result. The question-based marking result is information including the number of a question present on the educational material 10, accuracy judgment on the answer to the question, each score that is based on the accuracy judgment, and total score correlated with each other in the form of a table. The question-based marking result is output per educational material 10 from the information calculation part 39a.

With the above processing, the information calculation part 39a performs marking summation of the accuracy judgments entered on the educational material 10 to obtain the total store.

The processing result obtained by way of the above automatic marking processing, that is, respective total scores as a marking summation result of the accuracy judgments entered on the educational material 10 are used as information to be subjected to summation operation to be performed subsequently. Thus, the total scores shall be retained in memory used as a work area of the data processor 30 in association with the answerer information extracted by the answerer extraction part 38.

[Description of Summation Operation]

In the summation operation that follows the automatic marking processing, the total scores on the educational material 10 as a marking summation result by the information calculation part 39a are retained in a work area in association with answerer information. The information retained in the work area is used by the arithmetic operation part 39b to perform arithmetic operation on the information such as an average score an average score, overall ranking, and deviation value on a per class basis or on a per grade basis. On which items (information) the arithmetic operation part 39b performs arithmetic operation shall be preset. The arithmetic operation performed by the arithmetic operation part 39b is made by using a well well-known technique, so that the corresponding details are omitted.

[Description of Printout Processing]

In the printout processing, the calculation result by the automatic marking processing and arithmetic operation result by the summation operation are printed on the educational material 10 where the calculation result and the arithmetic operation result have been obtained.

In case a carrier path is provided between the scanner 20 and the printer 50 so that the carrier path is designed to automatically carry the educational material 10, the educational materials 10 are supplied to the printer 50 in the image reading order in the scanner 20. Thus, even in case a plurality of educational materials are batch processed, it is possible to properly maintain the relation between the calculation result by the automatic marking and the arithmetic operation result by the summation operation (hereinafter referred to simply as “printout contents”) and adequately deliver the printout contents on the educational material 10.

Even in case transfer of the educational material 10 from the scanner 20 to the printer 50 requires man power, it is possible to properly maintain the relation between the educational materials 10 and corresponding printout contents and adequately deliver the printout contents on the educational material 10 as long as the educational materials 1-are set in the feeder tray of the printer 50 while maintaining the image reading order in the scanner 20.

In case transfer of the educational material 10 requires manpower, a difference may be caused due to a working error between the order of image reading by the scanner 20 and the order of sheet setting into the feeder tray of the printer 50. Thus, identification of the educational material 10 as a target of printout is desirable in case transfer of the educational material 10 requires manpower.

To identify the educational material 10, the educational material 10 as a target of printout is read by a read sensor. The information reading need not be performed across the whole area of the educational material 10 but has only to be performed on areas contributing to identification, or to be more specific, the identification information column 10b and the answerer information column 10c. Thus, the read sensor to reading information is not like a scanner device but may be implemented by a CCD (Charge Coupled Device) sensor arranged between the feeder tray and the printer engine.

When the information is read by the read sensor, the information processing part arranged in association with the read sensor identifies the educational material 10 as a target of printout. The identification may be done in the similar manner to that of the above educational material determination part 33 or answerer extraction part 39 mentioned above. When the educational material 10 is identified, the result of identification is compared with the answerer information related to the printout contents of the printout and it is determined whether they match each other.

As a result of this determination, when there is a match, the relation between the educational material 10 and the corresponding printout contents are properly, so that the printer 50 continues output of the current printout contents. In case there is no match, it is highly possible that proper printout will fail, so that the printout is suspended and an alarm to that effect is issued. Or, in case there is no match, the printout contents matching the identification result of the educational material 10 may be retrieved from the information retained in the work area for printout on the educational material 10. With this procedure, it is possible to reliably print data on the educational material 10 even in case transfer of the educational material 10 requires manpower.

Printout on the educational material 10 is made by using a well-known electronic photography technique. The printer 50, receiving the calculation result by the information calculation part 39a and the arithmetic operation result by the arithmetic operation part 39b, decomposes the results, converts the results into a data format that may be output from the printer 50 and prints the resulting data on the educational material 10.

The printout is made on a specific area of the educational material 10, to be more specific, the information output column 10d. The printer 50 has to recognize the position of the information output column 10d before decomposing received data. Recognition of the position of the information output column 10d may be made based on the position of a score output target area identified from the recognition target area information that has been acquired by the target area acquisition part 34.

With the processing in the printer 50, the calculation result by the automatic marking and the arithmetic operation result by the summation operation are printed in the information output column 10d of the educational material 10 where the calculation result and the arithmetic operation result are obtained.

Printout on the printer 50 need not necessarily performed on both of the calculation result by the automatic marking and the arithmetic operation result by the summation operation but should be performed at least on the calculation result by the automatic marking. This is because the arithmetic operation result by the summation operation is associated with the calculation result by the automatic marking.

As described above, according to the educational material processing apparatus, the educational material processing method and the educational material processing program of this embodiment, the additional accuracy judgment contents (for example, a figure shape of “O” or “x”) are recognized based on the image data read from the educational material 10. After the accuracy judgments entered on the educational material 10 are subjected to marking summation, the marking summation result (for example, a total score, an overall ranking and an average score) is printed on the educational material 10 as a source of image data reading. Thus, the educational material 10 that includes accuracy judgments added thereon is subjected to automatic summation of the accuracy judgments through image reading from the educational material 10, which saves the marking on the educational material 10. The marking summation result is printed on the educational material 10 so that an answer entering person readily recognizes the marking summation result by referring to the post-marking summation educational material 10.

In the marking summation process, the image data read from the educational material 10 is analyzed and the electronic data on the original of the educational material 10 is retrieved. At the same time, a recognition target area on the original is grasped from the electronic data on the retrieved original and the additional contents in the grasped recognition target area is extracted. Thus, the recognition target area is identified in marking summation so that only the additional contents in the recognition target area should be extracted, which speeds up the recognition of the additional contents with favorable accuracy. Further, the recognition target area is grasped from the electronic data on the retrieved original based on the image data read result. As long as the electronic data on the original is stored in advance, a recognition target area on each of various types of educational materials 10 is automatically identified without additional workload such as entry of the specific type of the educational material in the marking summation process, even in case marking summation of various types of educational materials 10 is made.

As mentioned above, the educational material processing apparatus, the educational material processing method and the educational material processing program according to this embodiment provides labor-saving of the marking summation process on an educational material 10 used by an educational institution while assuring favorable accuracy, without additional workload. The invention is thus highly convenient in use by an educational institution by providing for a highly reliable marking process.

The educational material processing apparatus, the educational material processing method and the educational material processing program according to this embodiment grasps the recognition target area on the original necessary for marking summation as well as the score output target area on the original so as to print the marking summation result in the score output target area. Thus, even in case various types of educational material 10 are subjected to marking summation processing and the processing result is printed on the educational material 10, the printout is made on a proper position, which adds to reliable marking processing.

While a specific preferable embodiment of the invention has been described, the invention is not limited thereto.

For example, in the retrieval of electronic data on the original of the educational material 10, the result of at least either the title analysis or code analysis on the educational material 10 is used in this embodiment. In general, the title of the educational material 10 is assigned to discriminate itself from others. Code information is assigned for a similar reason. Use of the analysis result of the title analysis or code analysis assures quick and to-the-point retrieval.

However, retrieval of electronic data on the original need not necessarily be based on the result of the title analysis or code analysis. For example, in case ID information (such as an ID number) is individually attached to the original of the educational material 10, electronic data on the original may be retrieved based on the analysis result of the ID information.

It is also possible to analyze the image characteristic amount (for example the pixels distribution on an educational material in the form of a histogram) on the image data obtained through image reading and retrieve the electronic data on the original based on the analysis result. Or, it is possible to perform layout analysis (for example, analysis of arrangement form of text portion and image portion) on the image data and retrieve the electronic data on the original based on the analysis result.

In case the original of the educational material 10 where question text is described, it is possible to perform character recognition on the question text and retrieve the electronic data on the original based on the character recognition result, because phrases or words of the question text is often inherent to the specific type of the educational material 10. In particular, for example in the educational material of “arithmetic”, in case words such as “addition” and “subtraction” are used per type of educational material 10, it is possible to identify the type of educational material 10 by determining the presence/absence of such words through character recognition. Further, while the marking of test papers is done to enter the figure (O) for a correct answer and the figure (x) for an incorrect answer in the embodiment as above, another figures may be used. For example, a check mark can be used for a correct answer.

In this way, the invention may be modified as required within the spirit and scope thereof.

The entire disclosure of Japanese Patent Application No. 2005-181385 filed on Jun. 22, 2005 including specification, claims, drawings and abstract is incorporated herein by reference in its entirety.

What is claimed is:

1. An material processing apparatus: comprising:
an original information memory that stores electronic data on a material having an answer column;
an image input unit that reads an image of the material in which at least the answer column includes an answer and an accuracy judgment on the answer is added, so as to obtain an image data from the material;
an original retrieval unit that analyzes the image data obtained by the image input unit and that retrieves an electronic data on an original of the material from which the image data was obtained out of the data stored in the original information memory;
a target area acquisition unit that grasps a recognition target area on the original from the electronic data on the original;
an additional data extraction unit that extracts additional contents in the recognition target area from the image data;
a calculation unit that performs marking summation of the accuracy judgment on the extraction result of the accuracy judgment out of the extraction result by the additional data extraction unit; and
a print unit that prints the marking summation result of accuracy judgment by the calculation unit on the material on which the accuracy judgment is added.

2. The material processing apparatus according to claim 1,
wherein the target area acquisition unit grasps the output target area on the original; and
the print unit prints the marking summation result of accuracy judgment by the calculation unit on the output target area grasped by the target area acquisition unit.

3. The material processing apparatus according to claim 1,
wherein the original retrieval unit retrieves the electronic data on the original based on the analysis result of code information individually embedded per original of the material.

4. The material processing apparatus according to claim 1,
wherein the original retrieval unit retrieves the electronic data on the original based on the analysis result of ID information individually assigned per original of the material.

5. The material processing apparatus according to claim 1,
wherein the original retrieval unit retrieves the electronic data on the original based on an analysis result of an image characteristic amount in the image data.

6. The material processing apparatus according to claim 1,
wherein the original retrieval unit retrieves the electronic data on the original based on the result of layout analysis on the image data.

7. The material processing apparatus according to claim 1,
wherein the original retrieval unit retrieves the electronic data on the original based on a recognition result of characters included in the image data.

8. An material processing method, comprising:
storing an electronic data on a material having an answer column;
obtaining an image data of the material by reading an image of a material in which at least the answer column is filled with an answer and an accuracy judgment on the answer is added;
retrieving an electronic data on an original of the material out of the stored data by analyzing the obtained image data;
grasping a recognition target area on the original from the retrieved electronic data on the original;
extracting additional contents in the recognition target area from the obtained image data;
calculating marking summation of the accuracy judgment on an extraction result of the accuracy judgment which is included in the extracted additional contents; and
printing the marking summation result of accuracy judgment by the calculating step on the material where the accuracy judgment is added.

9. A program product for enabling a computer to process a material, comprising:
software instructions for enabling the computer to perform predetermined operations; and
a computer-readable recording medium bearing the software instructions;
wherein the predetermined operations include:
storing an electronic data on an original of the material;
retrieving an electronic data on an original of the material out of the stored electronic data, by analyzing an image data of the material in which an answer column is filled with an answer and an accuracy judgment on the answer is added;
grasping a recognition target area on the original from the retrieved electronic data on the original;
extracting additional contents in the recognition target area from the image data;
calculating marking summation of the accuracy judgment on an extraction result of the accuracy judgment which is included in the extracted additional contents; and
making a printer print the marking summation result of accuracy judgment on the material on which the accuracy judgment is added.
